(19) United States
(12) Patent Application Publication
(10) Pub. No.: US 2018/0264602 A1
(43) Pub. Date: Sep. 20, 2018

(54) Vehicular Apparatus And Method For CNC Metal Cutting Operations At Unpowered Jobsites

(71) Applicant: Garrie Brian Bales, Mitchell, GA (US)

(72) Inventor: Garrie Brian Bales, Mitchell, GA (US)

(21) Appl. No.: 15/924,207

(22) Filed: Mar. 17, 2018

Related U.S. Application Data
(60) Provisional application No. 62/473,352, filed on Mar. 18, 2017.

(51) Int. Cl. B23K 37/02; B23K 31/10; B60P 3/14

(52) U.S. Cl. CPC B23K 37/0211; B23Q 1/015; B60P 3/14; B23K 31/10

(57) ABSTRACT

The present inventive concept discloses design providing for the mounting of a CNC cutting machine upon a sturdily framed wheeled vehicle. The “vehicular cutting machine” can then be transported upon its own integral structure, to practically any jobsite. This mobility is a particular advantage to the customer at the jobsite where there is a requirement for a smaller number of precision parts in a short time during a plant or facility start-up, shutdown, or power outage. The inventive concept presents a method of use of CNC cutting machines that has not been used in the metal-cutting industry, oftentimes because of harsh road environments or the sheer difficulty of designing and building a self-powered, self-equipped CNC cutting machine. The present inventive concept negates the problems previously encountered by the prior art, and makes possible a cutting machine which is transportable and immediately available for operation upon reaching a designated website.

### CROSS-REFERENCE TO RELATED APPLICATIONS

This is a non-provisional patent application which claims the benefit and priority of U.S. Provisional Patent Application No. 62/473,352 filed on Mar. 18, 2017, and currently co-pending before the USPTO, by reference as though said provisional patent application No. 62/473,352 appears fully herein.

### STATEMENT REGARDING FEDERALLY SPONSORED RESEARCH OR DEVELOPMENT

Not Applicable

### BACKGROUND OF THE INVENTION

### (1) Field of the Invention

The present invention relates to CNC cutting machines typically used for cutting materials and more particularly to a CNC cutting machine which is self-equipped, self-powered, and is mounted on a vehicle for transport to remote jobsites where electrical power is unavailable. The disclosed vehicular cutting machine 1 can cut complex industrial planar designs in a manner similar to large gantry machines permanently installed on a shop floor.

A CNC (computer numerical control) cutting machine is a cutting machine tool that uses computer software programs to automatically execute a series of cutting operations. Many types of CNC cutting machines are in existence which can provide some means for the automated cutting of materials. Although most of the prior art cutting machines are adequate and function as intended, the prior art devices possess one common disadvantage: they require considerable amount of set-up time and require several items of equipment and accessories to be positioned and hooked up to the CNC cutting machine before cutting operations begin.

### (2) Description of the Related Art, Including Information Disclosed Under 37 CFR 1.97 and 1.98 Includes

U.S. patent application Ser. No. 12/804,281; Jul. 19, 2010: The disclosed mobile CNC cutting machine is an automated CNC cutting machine affixed to a wheeled platform for rapid set-up on a remote job site. The machine is particularly well suited to cut metal materials, and is built on a solid metal structure for easy transporting to a job site and ready for use on arrival.

U.S. Pat. No. 7,404,754 July 2008 Lin; Disclosed is a CNC tungsten steel cutting machine suitably used to cut a metal material, such as tungsten carbide steel, includes an operational platform, a cutting mechanism, a feeding mechanism, a delivering mechanism, and a control panel. When a metal material to be cut is received in a feeding tray of the feeding mechanism, lifting control rods of the feeding mechanism lift the metal material until the metal material is temporarily positioned. Once the latest metal material is completely cut, the lifting control rods push the next metal material, so that the next metal material moves into the V-shaped guiding groove.

U.S. Pat. No. 7,114,754 October 2006 Morello; The invention is a vehicle for use in the construction trade to support steel building fabrication and support issues. In the preferred embodiment, the vehicle comprises a trailer, a mobile type unit containing enough equipment to handle most tasks used on a construction site, particularly a metal building construction site. The trailer has its own self-contained power and is fully supportive of a mobile metal building factory that is used commonly in the art. The vehicle is designed to serve as a mobile metal factory and will be used in the construction of self-supporting metal structures that are known in the industry, and is fully self-contained, supplying all of the tools and equipment necessary for construction support at the site where the vehicle is located.

U.S. Pat. No. 5,871,389 February 1999 Bartlett, et. al.: A CNC cylindrical grinding machine comprising a bed, a worktable movable relative to the bed along a linear path, wheelhead movable in a direction generally perpendicular to the direction of worktable travel, a rotatable grinding wheel mounted thereon for engagement with a workpiece mounted on the worktable, wheel drive means on the wheelhead for rotating the grinding wheel, headstock and tailstock means carried by the worktable for supporting a workpiece at its opposite ends, drive means associated with the headstock and tailstock means for rotating the workpiece, worktable drive means for effecting movement of the worktable relative to the bed and therefore the wheelhead, wheelhead drive means for effecting movement of the wheelhead and therefore the grinding wheel towards and away from the workpiece, control means by which all of the drive means and particularly the worktable and wheelhead drive means, are controlled, thereby to enable the workpiece to be positioned axially and rotationally relative to the grinding wheel.

U.S. Pat. No. 5,383,698 January 1995 Buchholz: Disclosed is a trailer for use in the construction trade. The trailer is fitted out with power saws and the like built in and is particularly adapted to accept long pieces of lumber for sawing. The trailer is distinguished by its open platform and cantilevered roof by which three open sides are provided so that longer pieces of lumber may be ripped.

U.S. Pat. No. 4,055,206 Oct. 1977 Griffin. In abstract, a preferred embodiment of this invention is a shop type composite trailer which can be folded to a compact size for transport and can be expanded during shop use. This trailer has an enclosure with shop type material processing equipment mounted therein. It also has means for removing the equipment from the enclosure while still attached to and supported by such enclosure. Additionally, it has supports for supporting the work material adjacent to the removed equipment.

In consideration of the previous summarizations of similar devices, it can be determined that a need exists for a CNC cutting machine that is not hindered by the operational restrictions described above. In particular, a need exists for a CNC cutting machine that is self powered and operationally-ready with a minimal set-up time. Additionally, this CNC cutting machine should be mobile in order to quickly reach a job site, which job site may not have electricity or a source of compressed air available.

### BRIEF SUMMARY OF THE INVENTION

The present inventive concept is an improvement of a CNC cutting machine which satisfies all the previously-described workplace needs. A primary object of the present invention, referred to as a “vehicular cutting machine,” 10 is to utilize it for cutting different types of material, particularly flat metal sheets at remote, unpowered worksites. The vehicular cutting machine 10 essentially uses a computer 46 to create the shapes to be cut and control whatever cutting mechanism 15 is operated by the vehicular cutting machine 10. The resulting shapes are smoother than would be possible with a human hand guided cutting mechanism, and can include intricate curves, inside cuts, and sharp corners.

The disclosed vehicular cutting machine 10 operates by means of motorized positioning of a gantry 20 and its attached trolley 115 along both an X-axis 27 and a Y-axis 28. The positioning operation enables the gantry 20 to travel fore and aft over a horizontally-oriented cutting area 25, while the attached trolley 115 is motorized to move laterally left or right over the cutting area 25. These movements are coordinated through pre-selected computer design programs in perfect synchronization so as to produce shapes of virtually any design. In certain embodiments, the same computer also controls the actuation of an oxygen-acetylene (oxy-fuel) torch 12, turning it on slightly before beginning a desired cut, thereby permitting it to burn through the material first. Other embodiments of the vehicular cutting machine 10 utilize a laser-powered 13 cutting mechanism or a plasma 14 cutting mechanism.

Another object of the vehicular cutting machine 10 is to design and construct the machine 10 so as to be immediately portable for transporting it to a remote and/or electrically un-powered worksite. To achieve the above object, the present inventive concept provides a vehicular-mounted CNC cutting machine integrally constructed onto on a wheeled, framed structure which may be towed onto any jobsite, and immediately available for use.

### BRIEF DESCRIPTION OF THE DRAWINGS

The objects, features, and advantages of the inventive concept presented in this application are more readily understood when referring to the accompanying drawings. The drawings, totaling ten figures, show the basic components, functions, and/or methods of use of the vehicular cutting machine 10. In the several figures, like reference numbers are used in each figure to correspond to the same component as may be depicted in other figures.

FIG. 1 presents a right-side view of the vehicular cutting machine 10, supported by its wheels 66 on rear tandem axles 65 and lift jacks 75(b).

FIG. 2 illustrates the left-side view of the vehicular cutting machine 10.

FIG. 3 presents a direct rear-end view of the vehicular cutting machine 10, further showing the trolley 115, gantry 20, and an attached cutting mechanism 15.

FIG. 4 is a stylized schematic rear view of the right linear guide rail mount assembly 162 as attached to the right rearmost vertical brace 200(b) by a liner guide rail mount 160.

FIG. 5 is a schematic illustration of the rear of the trolley 115 and its components.

FIG. 6 is a stylized side of the right side of the basic frame structure which supports the vehicular cutting machine 10, including the right-side upper beam 185 right-side lower beam 190, and vertical braces 200.

FIG. 7 is a plan view of the vehicular cutting machine 10, further showing the cutting area 25, the forward work floor 197, arrangement of equipment, and components.

FIG. 8 shows a right rear perspective view of the cutting machine 10, including the gantry 20, trolley 115, gas-powered air compressor 280, right stepper motor gear reduction 130(b), the right linear guide rail 35(b), and the computer console 45.

FIG. 9 depicts a right-side view of the vehicular cutting machine 10 with the addition of an umbrella 260 and further showing the location of the inverter-generator 240, and a plasma cutter 250 device.

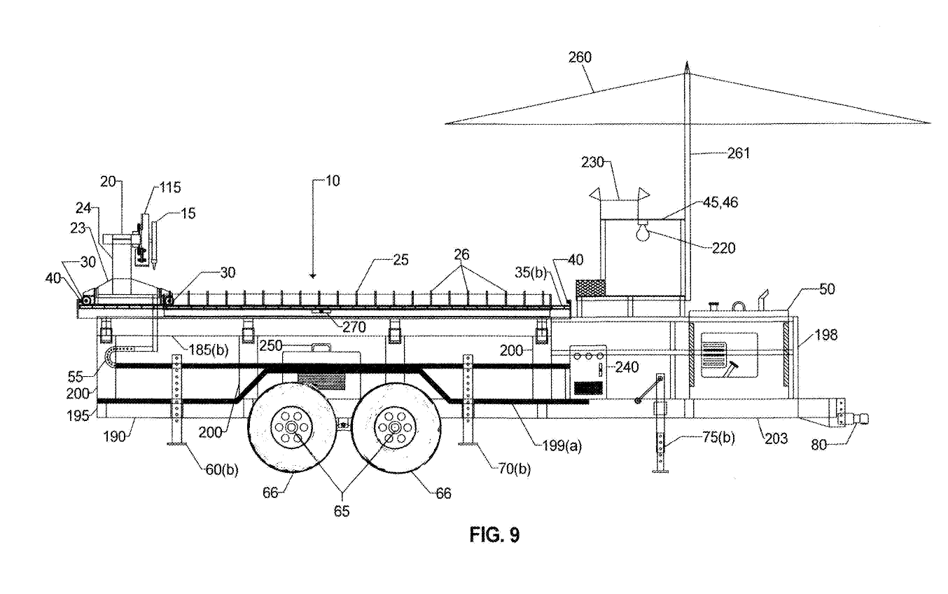

FIG. 10 illustrates a left-side view of the vehicular cutting machine 10, further showing the placement of oxygen tanks 90, 91, an acetylene tank 92, and gas control valves 85.

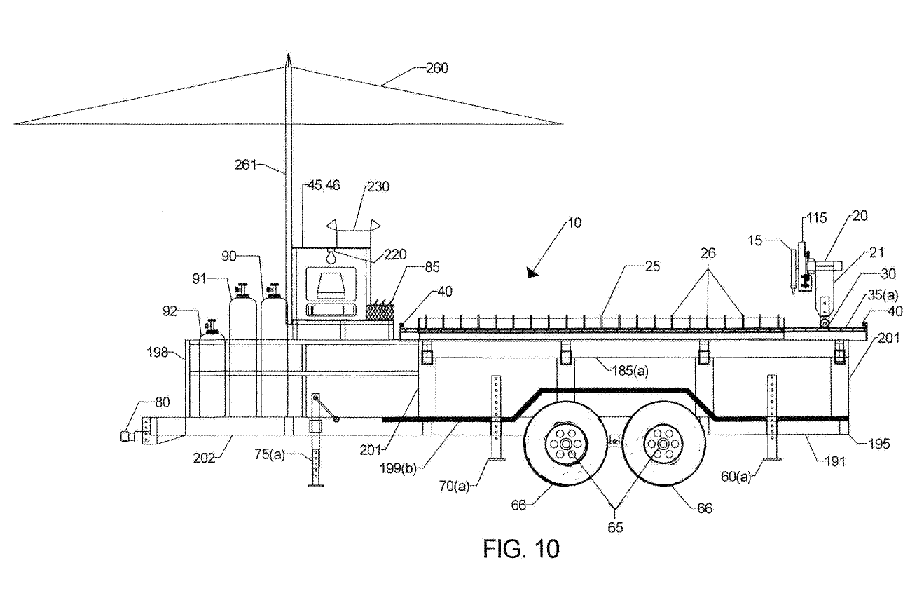

NOMENCLATURE FOR VEHICULAR CUTTING MACHINE

| | |
|---|---|
| 1.-9. | n/a |
| 10. | Vehicular cutting machine |
| 11. | n/a |
| 12. | Oxy-fuel cutting torch |
| 13. | Plasma cutting device |
| 14. | Laser cutting device |
| 15. | Cutting mechanism |
| 16.-19. | n/a |
| 20. | Gantry |
| 21. | n/a |
| 22. | Stepper motor gear reduction mount |
| 23. | Horizontal gantry beam assembly |
| 24. | Vertical gantry beam |
| 25. | Cutting area |
| 26. | Cutting area spacers |
| 27. | X-axis |
| 28. | Y-axis |
| 29. | n/a |
| 30. | Guide roller bearings |
| 35(a) | Left linear guide rail |
| (b) | Right linear guide rail |
| 40. | Rubber stops |
| 45. | Control console |
| 46. | Computer |
| 50. | Power supply 13,000 W generator |
| 55. | Cable and hose carrier |
| 60. | Rear retractable stabilizers |
| 65. | Rated tandem axles |
| 66. | Wheel |
| 70. | Front retractable stabilizers |
| 75(a) | Left lift jack |
| (b) | Right lift jack |
| 80. | Hitch |
| 81. | Tow bar |
| 82. | n/a |
| 85. | Gas control valves |
| 90. | Oxygen tank |
| 91. | Oxygen tank |
| 92. | Acetylene tank |
| 93.-99. | n/a |
| 100. | Trolley cable and hose carrier |
| 105. | Belt drive speed reducer belt |
| 108. | Trolley motor |
| 110. | Guide roller bearings |
| 114. | Trolley speed reducer |
| 115. | Trolley |
| 120. | Gear rack |
| 121.-129. | n/a |
| 130(a) | Left stepper motor gear reduction |
| (b) | Right stepper motor gear reduction |
| 133. | Motor |
| 135. | Set screws |
| 136.-154. | n/a |
| 155. | Hexagonal cap screws |
| 156.-159. | n/a |
| 160. | Linear guide rail mount |
| 162. | Support arm |
| 163. | Support plate |
| 165. | Cam follower bearings |
| 166. | Upper rail |
| 167. | Lower rail |
| 170. | Coil spring |
| 180. | Socket head cap screw |
| 175. | Set screws |
| 176.-184. | n/a |
| 185(a) | Left side upper beam |
| 185(b) | Right side upper beam |
| 190. | Right lower beam |
| 191. | Left lower beam |
| 192. | Left fender |
| 193. | Right fender |
| 194. | n/a |
| 195(a) | Upper lateral brace |
| 195(b) | Lower lateral brace |
| 196. | Main floor |
| 197. | Bow floor section |
| 198. | Railing |
| 199(a) | Right fender |
| 199(b) | Left fender |
| 200. | Right vertical brace |
| 201. | Left vertical brace |
| 202. | Left bow beam |
| 203. | Right bow beam |
| 205.-209. | n/a |
| 210. | Retractable electric cord |
| 220. | Light |
| 230. | Spotlight |
| 240. | Inverter-generator |
| 241.-259 | n/a |
| 260. | Umbrella |
| 261. | Umbrella shaft |
| 270. | Tubular level |
| 280. | Gas-powered air compressor |
| 290. | Retractable air hose reel |

### DETAILED DESCRIPTION OF THE INVENTION

The following description includes the preferred embodiment for carrying out the inventive concept disclosed. This description is not to be taken in a limiting sense, but is made merely for the purpose of describing the general principles of operation of the vehicular cutting machine 10. The scope of the concept is further defined by the claims accompanying this disclosure.

Customarily, a CNC cutting machine is set up on the shop floor inside a building, the building further having electrical wiring of suitable voltage and amps, and a source of compressed air, oxygen, and acetylene. A user or intended customer must physically bring the materials to be cut to the building, where the CNC cutting machine can then be set up to perform the work. The result is that efficiency is less than desirable due to the labor and time spent in transporting the raw materials in preparation for set up of the cutting job. The concept of a trolley containing a cutting mechanism and mounted onto a gantry-type structure which travels on parallel tracks is known in the metal-cutting industry. However the present inventive concept presents a unique and advantageous design, featuring immediate mobility of a cutting machine which is self-equipped, self-powered, and a construction enhancing entity in itself

The present inventive concept is a design allowing a CNC cutting machine to be mounted on a sturdily framed wheeled vehicle. Referred to as the “vehicular cutting machine” 10, this apparatus can then be transported upon its own structural frame, to practically any jobsite. This mobility is a particular advantage to the customer at the jobsite where there is an immediate requirement for a small number of precision parts in a short time during a plant or facility start-up, shutdown, or power outage. This type of wheeled, transportable CNC cutting machine has not been used in this industry, oftentimes because of harsh road environments. The present inventive concept negates the problems previously encountered by the prior art, and makes possible a transportable, vehicular CNC cutting machine 10.

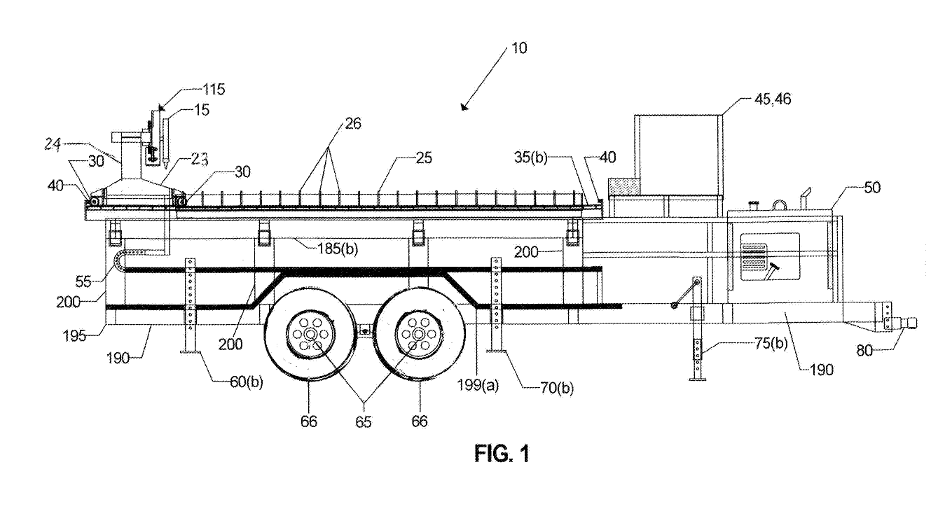

FIG. 1 presents a right-side view of the vehicular cutting machine 10 in a stationery position, whereby it is supported by its wheels 66 mounted on rear tandem axles 65, a right lift jack 75(b), and left lift jack 75(a) (out of view). The lower section of the vehicular cutting machine 10 extends from a right lower beam 190, integrally to a right bow beam 203, and culminates in a tow bar 81 and a hitch 80. Four right vertical braces 200 extend upwards from the right lower beam 190 to support a right-side upper beam 185(b). A right linear guide rail 35(b) is mounted atop the upper beam 185(b) in order to support movement of two guide roller bearings 30 which are affixed to a right gantry base 23. A right vertical gantry beam 24(b) connects the gantry base 23 to the upper gantry 20, thereby enabling movement of the gantry 20 longitudinally along the right linear guide rail 35(b), corresponding to the X-axis 27 of a computer-generated program. Rubber stops 40 limit horizontal travel of the guide roller bearings 30 as necessary.

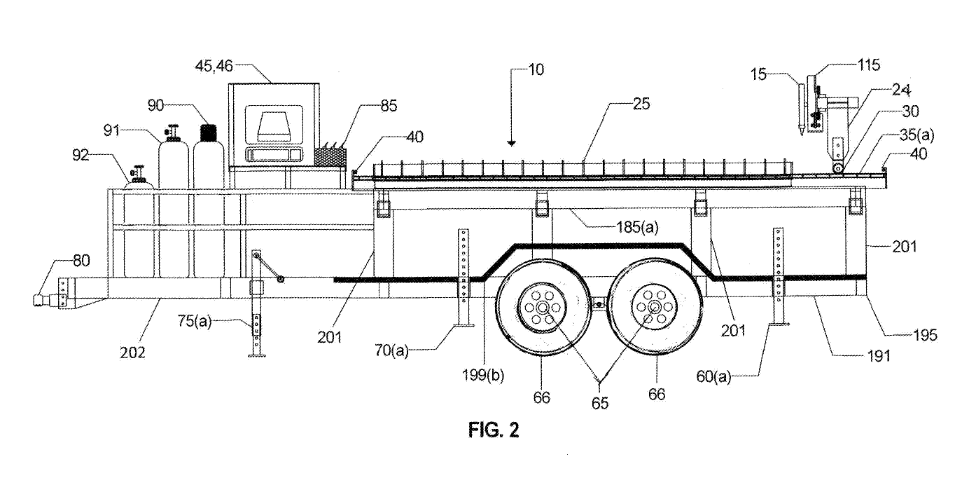

In viewing FIG. 2, there is presented a left-side view of the vehicular cutting machine 10 in the stationery position, by wheels 66 mounted on rear tandem axles 65, a left lift jack 75(a), and right lift jack 75(b) (out of view). The lower section of the vehicular cutting machine 10 is shown to extend from a left lower beam 191, integrally to a left bow beam 202, and culminates in a tow bar 81 and a hitch 80. Four left vertical braces 201 extend upwards from the left lower beam 191 to support a left-side upper beam 185(a). A left linear guide rail 35(a) is mounted atop the left-side upper beam 185(a) the left linear guide rail 35(a) serving to control movement of a single guide roller bearing 30 which roller bearing 30 is affixed to a left gantry vertical beam 22.

The left gantry vertical beam 22 connects to the upper gantry 20, which in turn, allows movement of the gantry 20 longitudinally along the left linear guide rail 35(a), corresponding to the X-axis 27 of a computer-generated program. Rubber stops 40 limit horizontal travel of the guide roller bearing 30.

To ensure a stable platform for performing cutting operations, left and right front retractable stabilizers 70(a), 70(a) along with left and right rear retractable stabilizer 60(a), 60(b) may be extended onto the surface upon which the vehicular cutting machine 10 rests.

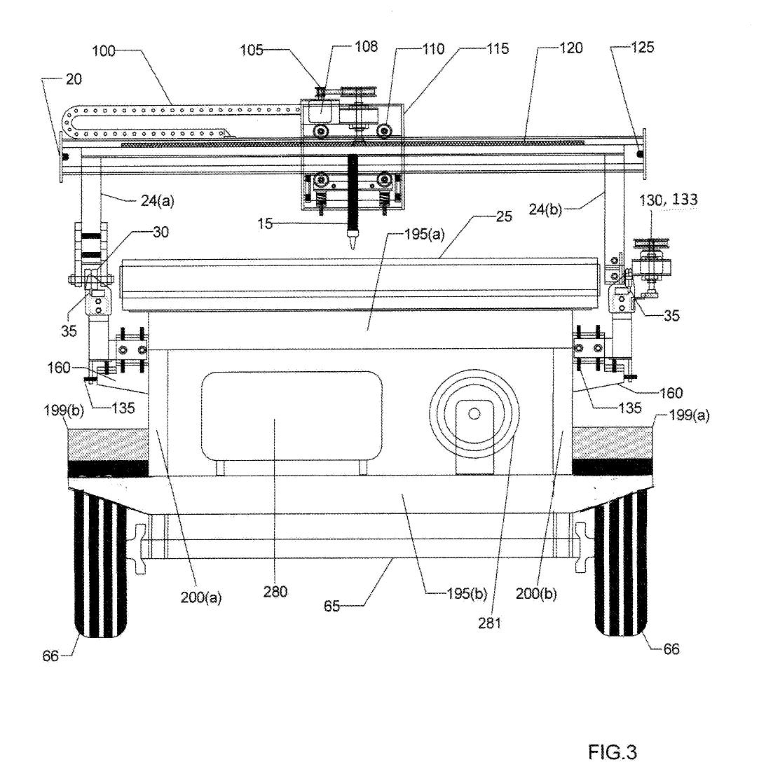

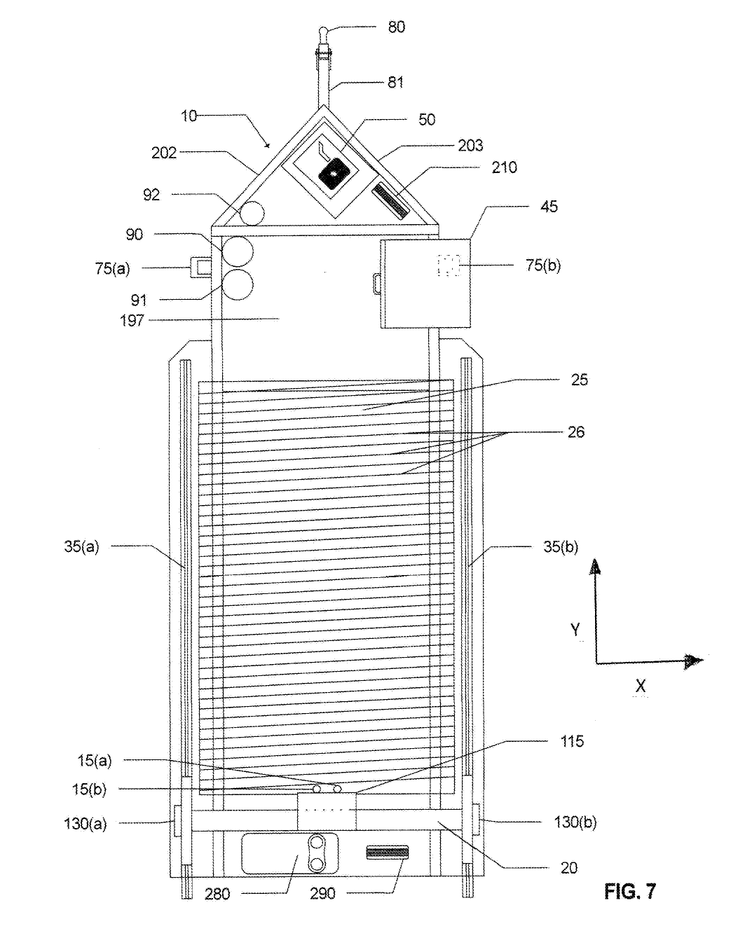

As is shown in FIG. 1, FIG. 2, and FIG. 3, the vehicular cutting machine 10 is depicts installation of a desired cutting mechanism 15 mounted on a trolley 115, which trolley 115 is mounted onto the upper section of the gantry 20. A motor 108 (shown in FIG. 3) connected to the trolley 115 serves to position the trolley 115 laterally, from side-to side, along the X-axis 27 of a cutting area 25 atop the vehicular cutting machine 10 (also, reference FIG. 7). The trolley 115 is mounted atop the upper horizontal section of the gantry 20.

The gantry 20 is powered by an electric motor 133, which motor 133 is also moderated by a stepper motor gear reduction system 130 (shown in FIG. 3). The motor 133 positions the entire gantry 20, including the attached trolley 115 and cutting mechanism 15, fore and aft along the Y-axis 28 of the cutting area 25. Reference is given to FIG. 7, which shows the plane of the cutting area 25, in addition to the orientation of the X axis 27 and the Y-axis 28 utilized by a computer 46 in programming material cutting operations

As previously described, the trolley 115 is mounted on a gantry 20 which is supported upon two right-side guide roller bearings 30, and one left-side roller bearing 30. In this manner, the gantry is enabled longitudinal movement of the entire gantry 20 on the horizontal linear guide rails 35(a), (b) which corresponds to the Y-axis 27 of a computer 46—generated cutting program. The guide roller bearings 30 allow the gantry 20 to roll atop the two linear rails 35 which run the length of the cutting area 25 of the cutting machine 10.

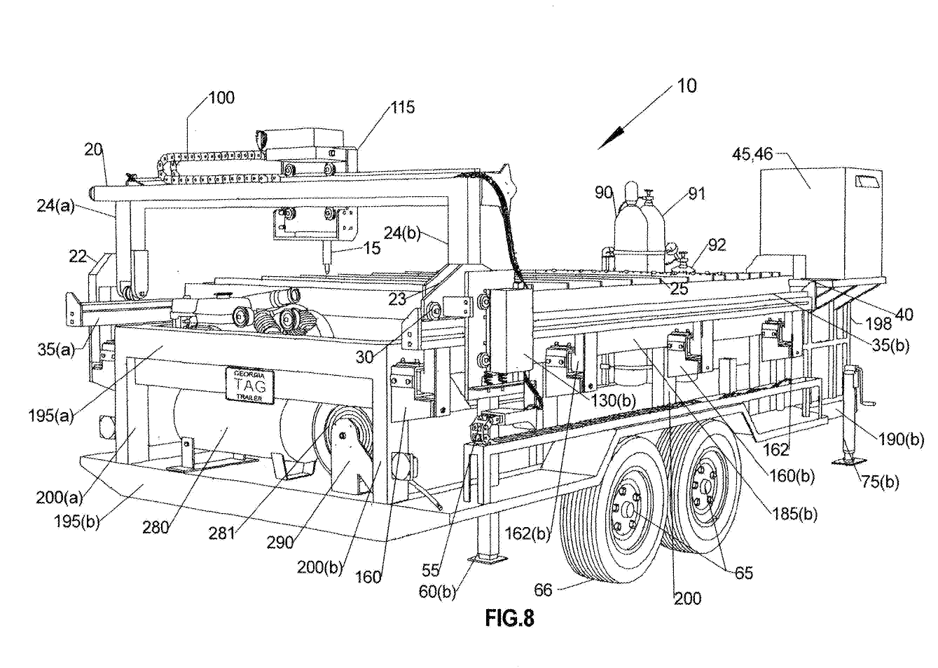

As shown in FIG. 8, the gantry 20 further comprises left and right vertical gantry beams 24 which extend downward to provide housings for pins coaxially running through the left- and right-side roller bearings 30. Further shown in FIG. 8 is a horizontal gantry beam assembly 23 mounted to the right vertical gantry beam 24(b) and also provides mounting for the right stepper motor gear reduction 130(b). A cable and hose carrier 55 (shown in FIG. 1 and FIG. 8) is provided to festoon any cable and hose connections from the computer control console 45, power supply 50, oxygen tanks 90, 91, acetylene tank 92, and gas control valves 85 to the gantry 20.

The control console 45 is used to display and set operational parameters for operating the vehicular cutting mechanism 15. The control console 45 houses any type of industrial computer 46 with a processor and hard drive to include a programmable logic controller (PLC) or personal computer. The control console 45 is the location upon the vehicular cutting machine 10 from which a user/operator processes the software that controls the cutting process.

Typically, CAD/CAM (Computer Aided Design/Computer Aided Manufacturing) type software is used to program the vehicular cutting machine's 10 operations. The user will occupy the bow floor space 197 (shown in FIG. 7) in close proximity to the control console 45. The control console 45 may also be used to interface with a laptop or other portable computer to receive programming instructions. The laptop or portable computer includes a wireless card to receive programming software via a wireless network. The operator of the vehicular cutting machine 10 stands on the bow floor section 197, and is ensured some degree of safety by means of a railing 198 in place. The operator then has ready access to the control console 45, gas control valves 85, and any required programming or configuration of the desired cutting mechanism 15.

In different embodiments, the cutting mechanism 15 may be an oxy-fuel cutting torch 12, a plasma cutting device 13, or a laser cutting device 14. In the preferred embodiment, the frame structure for the vehicular cutting machine 10 is fabricated from 3.0 inch by 6.0 inch, by ¼ inch thick steel tubing. The steel tubing for the right and left lower beams 190, 191 is typically 20.0 inches in length. The vertical braces 200, 201 and lateral braces 195(a), (b) are joined symmetrically, from side-to-side at opposite locations to provide a rigid frame design which is built to withstand all traveling conditions, including rough road conditions. Adjustable rear retractable stabilizers 60(a), (b), front retractable stabilizers 70(a), (b), a 500-pound rated hitch 80, and right and left lift jacks 75(a), (b) are attached to the right and left lower beams 190, 191 of the frame. In the preferred embodiment, the entire vehicular cutting machine 10 rests upon a structural frame connected to 5,200 lb.-rated, tandem axles 65.

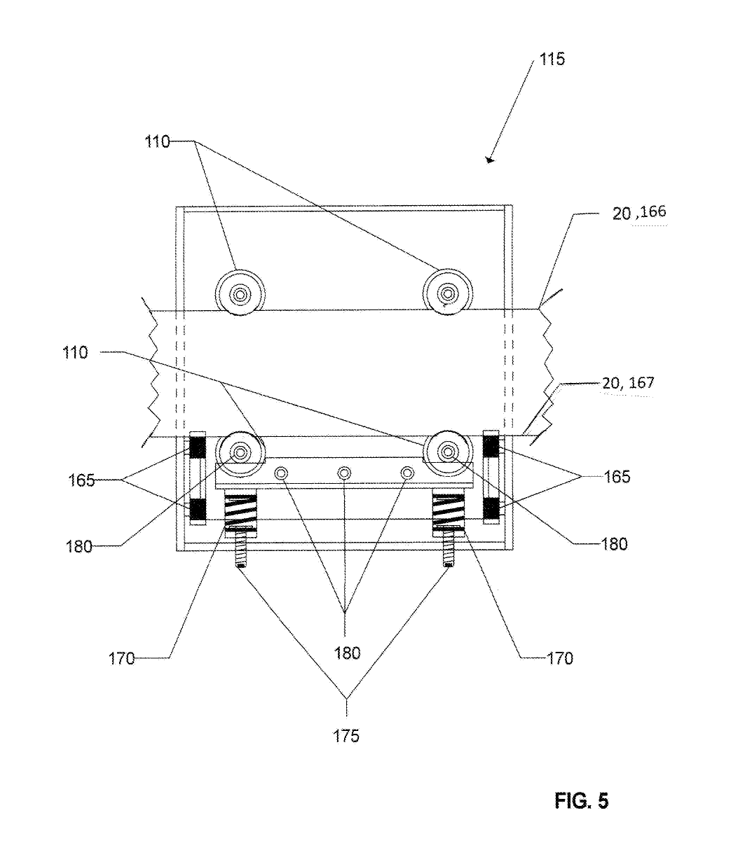

As shown best in FIG. 3 and FIG. 5, the end view of a vehicular CNC cutting machine 10 shows in greater detail the trolley 115 mounted on the gantry 20. The trolley 115 is mounted to the gantry 20 with four guide roller bearings 110. The trolley motor 108 is connected to a trolley speed reducer 114 (not shown) by a belt drive speed reducer belt 105. The trolley speed reducer 114 is attached to a geared shaft which is propelled along the gear rack 120. The cutting mechanism 15 is attached to the trolley 115 and is positioned downwards towards the cutting area 25. The trolley 115 runs approximately the entire left-right width of the cutting area 25.

As shown in FIG. 3, a trolley cable and hose carrier 100 festoons the cables and hoses to the trolley motor 108 and cutting mechanism 15. A belt drive speed reducer belt 105 is controlled by the trolley motor 108. In operating the vehicular cutting machine 10, various cutting mechanisms may be used, including plasma 13, acetylene-oxygen 12, and laser cutting mechanisms 14. Each end of the gantry 20 is provided with rubber stops 125 to cushion the impact of the trolley 115 during operation.

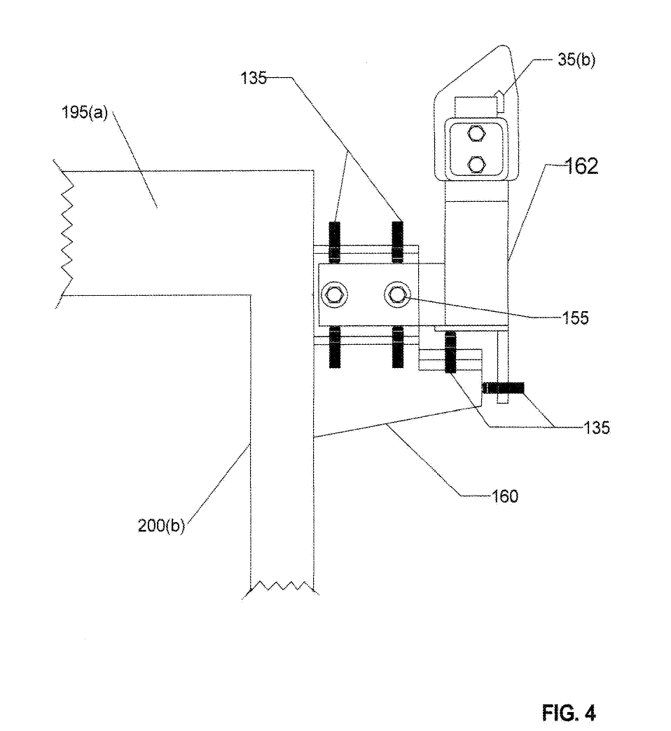

As shown in FIGS. 3, 4, and 8, a linear guide rail mount 160 is attached at each vertical brace 200, 201 of the vehicular cutting machine 10. Support arms 162 provide the mechanical bracing to attach the linear guide rail mount 160 to the vertical brace 200. Further, each support arm 162 provides a foundation to support and attach each of the linear guide rails 35(a), 35(b). Set screws 135 and hexagonal cap screws 155 are provided to adjust the left and right linear guide rails 35(a), 35(b). The linear guide rail mount 160 is designed to adjust inwards and outwards, up and down, and tilt from side to side. The design allows the user to easily adjust the linear guide rails 35(a), 35(b) to maintain proper alignment. In FIG. 4, the right linear guide rail 35(b) is out of view, atop the rearmost support arm 162 of the right side of the vehicular cutting machine 10.

In viewing FIG. 5, the manner in which the trolley 115 is transported along the gantry 20 is shown. The gantry 20 further comprises an upper guide rail 166 and a lower guide rail 167. A “lower guide rail assembly” provides tension for loading onto the lower guide rail 167. The assembly operates in its place by vertically-mounted cam follower bearings 165 in such a way that maintains proper lower and upper rail alignment. The trolley 115 functions efficiently through the provision of four guide roller bearings 110 that connect the trolley 115 to the gantry 20. The guide roller bearings 110 are adjusted by set screws 175, socket head cap screws 180, and coil springs 170. Also, cam follower bearings 165 help hold the lower guide roller bearing assembly, which is spring loading the trolley 115 to the gantry 20 from the side.

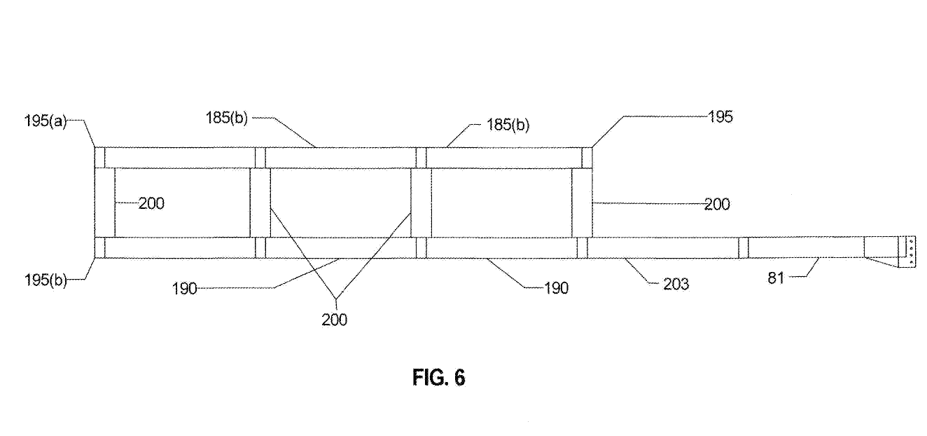

Referring to FIGS. 1-6, in the preferred embodiment of the vehicular cutting machine 10, all elements as described above are used to manufacture the vehicular cutting machine 10. FIG. 3 illustrates a direct view of the rear of the vehicular cutting machine 10. Again, there is shown a cutting mechanism 15 attached to the trolley 115, which is rollingly affixed to the gantry 20. A trolley motor 108 energizes the trolley 115 to move to the left and right, along the designated X-axis 27 of the cutting surface 25. The gantry 20, resting atop the left and right linear guide rails 35(a), (b), positions the trolley 115, along with the cutting mechanism 115, along the designated Y-axis 28 of the cutting surface 25. In this manner, a workpiece can be cut accurately and precisely with the computerized positioning of the gantry 20 and trolley 115.

In actual industrial use, an operator/driver typically tows the vehicular cutting machine 10 to the jobsite with a standard truck or other vehicle that has a trailer hitch compatible with the hitch 80 of the vehicular cutting machine 10. The operator secures the vehicular cutting machine 10 in a level and stationary position by adjusting rear retractable stabilizers 60(a), 60(b), and front retractable stabilizers 70(a), 70(b), and left and right lift jacks 75(a), 75(b). The vehicular cutting machine 10 is further equipped with a tubular level 270 (not shown) which is an aid to achieving orientation parallel to the horizon.

The operator secures the material to be cut; typically flat metal sheets, in the cutting area 25. The operator at the control console 45 sets operation parameters by interfacing the control console 45 with a laptop or desktop computer 46, so as to carry out a completely automatic cutting operation without manual processing, and providing precise and speedy cutting of the material.

A laptop or desk-mountable computer 46 uploads the appropriate CAD/CAM software for the particular job. The operator also checks for any last-minute cutting parameter changes in the job over a wireless network, integral to the control console 45. The operator, by means of the CAD/CAM software, controls the positioning of the gantry 20 and trolley 115. The gantry 20 positions the cutting mechanism 15 along the Y-axis 28 of the material to be cut in the cutting area 25. The trolley 115 then positions the cutting mechanism 15 along the X-axis 27 of the material to be cut in the cutting area 25. The X-axis 27 and Y-axis 28 motion of the cutting mechanism 15 allows precise cuts of any shape or design as set from the control console 45.

FIG. 7 presents a plan view of the vehicular cutting machine 10. A horizontal, rectangular cutting area 25 takes up substantially most of the upper exposed surface of the vehicular cutting machine 10. A tow bar 81 is constructed to connect to the left bow beam 202 and right bow beam 202 of the frame. The V-shape of the beam bow section 202, 203 is to allow ease of turning when the vehicular cutting machine 10 is hitched to a truck or other vehicle towing the vehicular cutting machine 10. A trailer hitch 80 is permanently affixed to the tow bar 81. An acetylene tank 92 is stored in the bow 81 section, as is a power supply 50, and a retractable electric cord 210. Two oxygen tanks 90, 91, along with an acetylene tank 92 are stored on the bow floor 197 of the front segment of the vehicular cutting machine 10, along with the operator's control console 45 (refer to FIG. 7).

FIG. 7 depicts the plan view of the vehicular cutting machine 10. A plurality of metallic planks, or spacers 26 are placed apart in a parallel manner and symmetrically from the base of the gantry 20 forward toward the front section of the vehicular cutting machine 10. The spacers 26 provide a generally horizontal cutting area 25 upon which any material is positioned and secured in preparation for the precision cutting process.

FIG. 8 presents a view of the right rear quarter-section of the cutting machine 10. The most prominent features shown in FIG. 8 include the gantry 20 vertical beams 24(a), (b), left gantry base 22, and right gantry base 23, the upper and lower lateral braces 195 (a), (b), and right vertical braces 200. A partial view of the right linear rail 35(b) is shown, along with the right linear guide rail mounts 160(b). Two length-wise lower longitudinal beams 190(a), (b) support the front and rear structural members of the vehicular cutting machine 10.

The right upper beam 185(b) supports the right linear rail 35(b). Four support arms 162(b) support and attach four right-side linear guide rail mounts 160(b) to right vertical braces 200, 200(b) and consequently, to the right upper beam 185(b). The vertical gantry beams 24(a), (b) are attached to guide roller bearings 30 which make contact with the respective left and right linear guide rails 35(a), 35(b). The gantry 20 moves fore and aft, atop the left and right linear rails 35(a), 35(b), along the designated “Y-axis” of the cutting surface 25.

Also shown in FIG. 8 is the trolley 115, which receives and secures a cutting mechanism 15. The trolley 115 attached to the top horizontal arm of the gantry 20. The rear end of each of the left and right linear guide rails 35(a), (b) are supported atop an upper horizontal brace 195(a), the brace 195(a) is in turn attached to left and right vertical braces 200(a), (b) which braces mount atop a lower horizontal brace 195(b). A gas-powered compressor 280, along with a connected hose 281 and retractable air hose reel 290 are shown.

Compared with the conventional CNC cutting machines, the vehicular cutting machine 10 provides several new functions and advantages. The vehicular cutting machine 10 carries out the completely automatic cutting operation without manual processing. A significant feature of the vehicular cutting machine 10 is that its mobility saves manpower and set-up time. While a prior art CNC machine is going through its set-up stages, it cannot be producing required work pieces, which amounts to non-productive time which cannot be recovered. The reduction in set-up time reduces the manufacturing costs. The vehicular CNC cutting machine 10 can be towed in to a worksite and typically set-up in less than 15 minutes.

The vehicular cutting machine 10 is constructed with several different embodiments and operational features, including an operator's umbrella 260; a printer within the control console 45; an integral mobile hotspot within the control console 45 for providing a wi fi network; Windows-based CNC control software; a 13,000-watt portable generator; a retractable electric cord reel; and a gas-powered air compressor for CNC plasma cutting processes.

Many variations of this inventive concept will occur to those skilled in the art. Some variations include the vehicular CNC cutting machine dimensions; and the type of cutting mechanism. All such variations are intended to be within the scope and spirit of the inventive concept. Although some embodiments are shown to include certain features, the applicant specifically contemplates that any feature disclosed herein may be used together or in combination with any other feature on any embodiment of the invention. It is also contemplated that any feature may be specifically excluded from any embodiment of an invention.

What is claimed is:

1. An apparatus, being a mobile, integrally-equipped, and self-powered CNC cutting machine, comprising:
a wheeled, horizontally-oriented rectangular frame atop which a CNC cutting machine with an industrial category cutting mechanism is permanently mounted, the rectangular frame with a bow section, and further being integrally equipped with a tow hitch, left-side and right-side lift jacks, two rear retractable stabilizers, a high-wattage electric generator, a gasoline-powered air compressor, an inverter-generator, at least one oxygen tank, and an acetylene tank.

2. The apparatus as in claim 1, wherein the wheeled frame further comprises:
a) at least one paired set of wheels and road tires, the pair co-axially connected by an axle, said axle mounted underneath the frame and extending laterally across the frame;
b) a left longitudinal upper beam and a left longitudinal lower beam;
c) four left vertical braces connecting the left upper and lower longitudinal beams;
d) a right longitudinal upper beam and a right longitudinal lower beam;
e) four right vertical braces connected to the right upper and lower longitudinal beams;
e) an upper lateral brace connected to the rear ends of the left and right longitudinal upper beams;
f) a lower lateral brace connected to the rear ends of the left and right longitudinal lower beams;
g) a bow section culminating in a tow bar and hitch;
h) a floor attached to the upper surfaces of the left and right longitudinal lower beams;
i) a left fender and a right fender; and
j) a main floor and a bow section floor.

3. The apparatus as in claim 1, wherein the wheeled frame further comprises:
a) spaced-apart, and parallel metallic spacers attached to the upper surface of said wheeled frame, and extending from left-to-right between the left and right longitudinal upper beams;
b) a linear guide rail affixed atop each longitudinal upper beam, respectively;
c) a motorized gantry, controlled by a lower guide rail assembly, and mounted on its left and right atop vertical gantry beams running to each linear guide rail, respectively;
d) a motorized trolley rollingly attached to the top of said gantry, said trolley having a connector for interchangeable attachment of a variety of cutting mechanisms; and
e) a water-tight control console housing a desktop computer with CAD and CAM software, and Windows-based CNC control software.

4. The apparatus as in claim 1, wherein the wheeled frame further comprises:
a) a twin tandem axles and paired wheels rated at 5,200 pounds;
b) an operator umbrella;
c tubular levels;
d heavy-duty truck tires;
e) at least one retractable electric cord reel;
f) an inverter-generator;
g) a gasoline-powered compressor and air hose; and
h) a control console having a mobile hotspot;

5. A system for operating an internally-equipped, self-powered, and vehicularly-positioned CNC cutting machine apparatus with equipment for performing plasma metal cutting operations, laser cutting, and/or oxy-fuel metal cutting operations under conditions of an isolated, unpowered worksite, said apparatus capable of initiating said cutting operations within fifteen minutes of arrival at the designated worksite, the system comprising:
a wheeled, horizontally-oriented rectangular frame atop which a CNC cutting machine with an industrial category cutting mechanism is permanently mounted, the rectangular frame further having a bow section, and further being integrally equipped with a tow hitch, two lift jacks, two rear retractable stabilizers, a high-wattage electric generator, a gasoline-powered air compressor, an inverter-generator, at least one oxygen tank, and an acetylene tank.

6. The apparatus as in claim 5, wherein the wheeled frame further comprises:
a) spaced-apart, and parallel metallic spacers attached to the upper surface of said wheeled frame, and extending from left-to-right between the left and right longitudinal upper beams;
b) a linear guide rail affixed atop each longitudinal upper beam, respectively;
c) a motorized gantry, controlled by a lower guide rail assembly, and mounted on its left and right atop vertical gantry beams running to each linear guide rail, respectively;
d) a motorized trolley rollingly attached to the top of said gantry, said trolley having a connector for interchangeable attachment of a variety of cutting mechanisms; and
e) a water-tight control console housing a desktop computer with CAD and CAM software, and Windows

7. The apparatus as in claim 6, wherein the wheeled frame further comprises:
a) a twin tandem axles and paired wheels rated at 5,200 pounds;
b) an operator umbrella;
c tubular levels;
d heavy-duty truck tires;
e) at least one retractable electric cord reel;
f) an inverter-generator;
g) a gasoline-powered compressor and air hose; and
h) a control console having a mobile hotspot for generation of a wi-fi network.

8. A method for the rapid and mobile deployment and setup of a CNC cutting machine for CNC laser, plasma, or oxy-acetylene cutting operations at an isolated, unpowered worksite, the method comprising the steps of:
providing a rectangular frame structure having two pairs of wheels, each pair co-axially connected an axle, said axles attached to the underside of the frame structure;
permanently mounting a gasoline-powered generator on the frame structure;
installing a cutting mechanism integrally connected to a trolley and gantry combination atop the frame structure;
installing a control console on the upper surface of the frame structure;
installing a computer having software for operation of CNC cutting;
providing of a high-wattage spotlight on said platform;

9. The method as in claim 8, wherein the wheeled frame further comprises:
a) spaced-apart, and parallel metallic spacers attached to the upper surface of said wheeled frame, and extending from left-to-right between the left and right longitudinal upper beams;
b) a linear guide rail affixed atop each longitudinal upper beam, respectively;
c) a motorized gantry, controlled by a lower guide rail assembly, and mounted on its left and right atop vertical gantry beams running to each linear guide rail, respectively;
d) a motorized trolley rollingly attached to the top of said gantry, said trolley having a connector for interchangeable attachment of a variety of cutting mechanisms; and
e) a water-tight control console housing a desktop computer with CAD and CAM software, and Windows

10. The method as in claim 8, wherein the wheeled frame further comprises:
a) a twin tandem axles and paired wheels rated at 5,200 pounds;
b) an operator umbrella;
c tubular levels;
d heavy-duty truck tires;
e) at least one retractable electric cord reel;
f) an inverter-generator;
g) a gasoline-powered compressor and air hose; and
h) a control console having a mobile hotspot for generation of a wi-fi network.
